(19) United States
(12) Patent Application Publication
(10) Pub. No.: US 2019/0362400 A1
(43) Pub. Date: Nov. 28, 2019

(54) DIGITAL CONTENT COMMERCE MANAGEMENT DEVICE, DIGITAL CONTENT COMMERCE MANAGEMENT METHOD, AND PROGRAM

(71) Applicant: Thermopyle Co. Ltd., Kyoto (JP)

(72) Inventor: Kentaro Onizuka, Kyoto (JP)

(21) Appl. No.: 16/461,742

(22) PCT Filed: Oct. 3, 2017
(86) PCT No.: PCT/JP2017/035910

§ 371 Date: May 16, 2019

(30) Foreign Application Priority Data
Nov. 17, 2016 (JP) 2016-224123
Apr. 5, 2017 (JP) 2017-075547

(51) Int. Cl. G06Q 30/06; G06Q 20/12; G06Q 40/04

(52) U.S. Cl. CPC G06Q 30/0619; G06Q 40/04; G06Q 20/123

(57) ABSTRACT

A commerce management device (1) is comprised of a transaction log; a sales quantity calculator (113) that calculates a quantity of sales of a digital product; a resell order count calculator (114) that calculates a resell order count based on a resell order form that is issued by a participant and recorded in a digital product resell order queue; and a price determiner (112) that determines the price in the next transaction by employing a monotonically increasing mathematical function that calculates a transaction price by taking, as an argument, a net quantity of sales obtained by subtracting the resell order count from the quantity of sales.

### TECHNICAL FIELD

The present disclosure relates to a digital product commerce management device, a digital product commerce management method, and a program.

### BACKGROUND ART

Electronic commerce systems for buying and selling digital products have been proposed (see Patent Literature 1, for example). In such electronic commerce systems, those who sell digital products set a price upon a digital product so as to recover investment in the development of the digital product, investment in business operations for marketing the digital product, and so on, and also to make profits. For those purposes, the sellers need to forecast trends in demand for digital products estimating approximate quantity of sales, how the copies of the digital product would sell.

### CITATION LIST

### Patent Literature

Patent Literature 1: Unexamined Japanese Patent Application Kokai Publication No. 2010-272033

### SUMMARY OF INVENTION

### Technical Problem

According to principles of microeconomics, the quantity of sales of a general commodity depends on its price. This is because demand/supply curves are given with respect to the price. However, a usual demand/supply curves cannot be applied to digital products because their marginal cost for reproduction and distribution are regarded as zero and thus the supply always meets the demand, in principle. Therefore, it is difficult to estimate how many copies of a digital product would sell. Consequently, setting a fair price upon a digital product based on the quantity of sales is particularly difficult.

In addition, in an electronic commerce market for digital products, copies of digital products purchased are prone to be further copied and redistributed to the third parties with or without charge in unauthorized manner. This is because of the fact that digital products are easily copied by the information processing devices themselves that are employed for playing, viewing, or appreciating those digital products without special devices, and the digital products are easily redistributed since those information processing devices are connected to global digital networks. Unauthorized reproduction and redistribution of digital products result in serious damage to the producers of those digital products. In general, crackdowns on unauthorized reproduction and redistribution are ordered under the laws and regulations for intellectual property rights, including copyright laws. However, it is difficult to enforce crackdowns because such unauthorized reproductions and redistributions are done privately and extensively and are hardly detected. One of the possible countermeasures for such situations is permitting the buyer to resell the digital products, which the buyer has once bought, to a third party at a price not significantly different from, or even higher than, the purchase price, when the buyer no longer needs support, updates, or other services provided by the producer, thereby repressing unauthorized reproductions and redistributions of the digital products. However, if reselling is allowed for digital products, the producers have to set price for reselling in addition to setting a fair price for digital products. Besides, a certain price for reselling might further induce unauthorized reproductions and redistributions. As a result, fair pricing may be more complex. Hence, difficult is smooth proceedings of electronic commerce of digital product.

In cases that multiple secondary products are derived from a single digital product (hereinafter called primary product), there arises another problem of how intellectual property rights should be handled by the producer of the primary product and those of secondary products. For example, consider a novel in Japanese as a primary product. Secondary products are those derived therefrom through translation or adaptation, such as English versions, comics, animation or live-action movies. Those secondary products are ready to be distributed as digital products. Further, consider a plan of commodity in the form of digital data as a primary product. The physical products actually manufactured from the plan are secondary products yet are not digital data. Conventionally, those producers or sellers of secondary products have to pay copyright fees or patent royalties in such an amount reasonable for producers of the primary product under copyright laws or patent laws. In such circumstances, however, the producers (or sellers) of secondary products could hide their reproductions from the primary product so as to avoid payments of copyright fees or patent royalties. Thus, in addition to inspecting any unauthorized reproductions or redistributions of primary products themselves, producers of primary products have to monitor various markets for those similar products, translations, adaptations, and commercial products that could have been derived from the primary products. Since an enormous amount of information and goods are currently distributed, monitoring those is extremely difficult and expensive. Any of such unauthorized or fraudulent uses, if detected, may be brought to a court under copyright laws or patent laws, which also involves considerable efforts and costs. Also, these existing frameworks repress innovation as they make it difficult to derive secondary products by casually using primary products.

The present disclosure has been created in view of the foregoing circumstances, and an objective of the present disclosure is to provide a digital product commerce management device, a digital product commerce management method, and a program that facilitate electronic commerce of digital products.

### Solution to Problem

To achieve the aforementioned objectives, a digital product commerce management device according to the present disclosure comprises,
a transaction log storage in which a transaction log regarding each digital product produced by a participant in the electronic commerce is recorded;
a sales quantity calculator that calculates, based on the transaction log, a quantity of sales of the digital product;
a resell order queue in which resell orders for the digital product by participants are enqueued;
a resell order count calculator that calculates the resell order count of the digital product, based on those resell orders enqueued in the resell order queue; and
a price determiner that determines a price in the next transaction by employing a monotonically increasing function that calculates the price by taking, as an argument, a net quantity of sales obtained by subtracting the resell order count from the quantity of sales, where an identical monotonically increasing function is applied to all digital products.

The digital product commerce management device according to the present disclosure may further comprise:
a referrers list in which digital products referring to the digital product are listed; and
a referrer sales quantity and resell order count calculator that calculates each net sales quantity of referrers, in the referrers list,
wherein the price determiner determines the price in the next transaction by employing a monotonically increasing function that calculates the price in the next contracted transaction by taking, as an argument, in addition to the net quantity of sales, each net quantity of sales of the referrers, where an identical monotonically increasing function is applied to all digital products.

The digital product commerce management device according to the present disclosure may further comprise:
a reseller determiner that identifies a participant who have resell-ordered for the digital product intending to resell that digital product to a participant intending to buy the digital product,
wherein, when no resell order exists, the reseller determiner identifies a participant who produced the digital product upon reception of a buy order for the digital product by a participant,

The digital product commerce management device according to the present disclosure may further comprise:
a resell order queue manager that manages the resell order by each participant,
wherein, when multiple resell orders exist, the reseller determiner identifies the participant who resell-ordered last among the multiple resell orders, upon the reception of the buy order by a participant.

The digital product commerce management device according to the present disclosure may further comprise:
a textboard provider that provides a textboard to the participant who produced the digital product, and to those participants whose participant identification number is in the product owners list that is a list of participant identification numbers of the participants who have bought and own the digital product.

In the digital product commerce management device according to the present disclosure,
a monotonically increasing function is a logarithmic function to base 2, multiplied by an exchange rate, where the logarithmic function takes, as an argument, a quantity obtained by adding 2 to the net quantity of sales.
A digital product commerce management method according to another aspect of the present disclosure is
a digital product commerce management method for managing electronic commerce of digital product, the method having the steps of:
calculating the quantity of sales of a digital product based on the transaction log of the digital product produced by a participant in electronic commerce of digital products;
calculating the resell order count of the digital product based on the number of resell order forms that the participants issued for the digital product; and
determining a price in the next transaction by employing a monotonically increasing function that calculates the price by taking, as an argument, the net quantity of sales obtained by subtracting the resell order count from the quantity of sales, where an identical monotonically increasing function is applied to all digital products.

A program according to another aspect of the present disclosure causes a computer to function as:
a sales quantity calculator that calculates the quantity of sales of a digital product, based on the transaction log of the digital product produced by a participant in the electronic commerce;
a resell order count calculator that calculates the resell order count of the digital product, based on resell orders for the digital product by the participant; and
a price determiner that determines the price in the next transaction by employing a monotonically increasing function that calculates the price by taking, as an argument, a net quantity of sales obtained by subtracting the resell order count from the quantity of sales, where an identical monotonically increasing function is applied to all digital products.

### Advantageous Effects of Invention

In a digital product commerce management device according to the present disclosure, a price determiner determines the price in the next transaction by employing a monotonically increasing function that calculates the price by taking, as an argument, the net quantity of sales obtained by subtracting the resell order count from the quantity of sales, where an identical monotonically increasing function is applied to all digital products. The price determiner may determine the price in the next transaction by employing a monotonically increasing function that calculates the price in the next transaction by taking, as arguments, the net quantity of sales obtained by subtracting the resell order count from the quantity of sales, and each net quantity of sales of the referrers, where an identical monotonically increasing function is applied to all digital products. In other words, the price of a digital product solely depends on the net quantity of sales obtained by subtracting the resell order count from the quantity of sales and on the net quantities of sales of those referrers, regardless of their specific products, data size, or who produced the product. Hence, the price of a digital product is automatically determined and changes dynamically with the increase or decrease in demand, and thus market prices of digital products in the commerce market are automatically and dynamically set, where participants who sell those products do not have to estimate the net quantity of sales of digital products beforehand. The transaction price of a digital product also rises with the increase in the net quantities of sales of its referrers. Thus, electronic commerce of digital products can be facilitated. The price determiner sets the price in the next transaction of a digital product by employing a monotonically increasing function that monotonically increases with the increase in the net quantity of sales, which reflects demand of participants for that particular digital product, and also monotonically increases with the increase in the number of its referrers and with the increase in their net quantities of sales. Thus, a higher transaction price is expected for such a digital product in increasing demand, and buyers may speculate to profit from reselling those digital products at a higher price than the purchase price.

Note that the amount a seller (or reseller) receives through a transaction may not necessarily be equal to the amount a buyer (or buyer of a resold product) pays for the transaction. Any difference between the amounts received and paid means a created value. This value creation is equivalent to mining in Bitcoin or other cryptocurrencies.

Even when the net quantity of sales of a digital product does not significantly increase, the transaction price of the digital product rises if the number of its referrers who refer to that digital product increases. Hence, the buyer may speculate profits in a fair manner without fraudulent activities such as unauthorized reproductions and redistributions of paid digital product that the buyer bought, whereby the effect of repressing unauthorized reproduction and redistribution performed by buyers of digital products is expected. In addition, the foregoing pricing method allows the buyer of a digital product to examine the digital product in order to decide which strategy to take, as such, waiting until the price rises in expectation of high demand if the digital product is speculated to be of high value, or shortly resell-ordering before the transaction price starts falling due to lower demand if the digital product is speculated to be of low value. In order to further raise value of a digital product, the buyer who bought the digital product is expected to actively advertise the digital product by, for example, recommending the buyer's acquaintances to buy it. As a result, excellent products will spread while their price rises. Furthermore, the increase in the number of its referrers raises the price of the digital product, thereby boosting the speculative value and demand for the digital product. This contributes to growth in sales of the primary digital product, without copyright fees or patent royalties being payed to the producer of the primary product by producers of referrers, namely secondary digital products. Thus, the producer of the primary digital product can obtain revenue equivalent to copyright fees or patent royalties. As there is no need to pay copyright fees or patent royalties, there is no occasion for fraudulent activities such as evading payment of copyright fees or patent royalties by referring to or citing the digital product without permission or otherwise fraudulently using the digital product. Thus, the price fluctuates with the quality evaluation made by all buyers as collective opinions and with the net quantity sales of the referrers. What is meant by this is that the transaction price represents the value of the digital product based on collective opinions of its buyers as well as of the producer and buyers of the referrers, and the transaction price represents a more reliable value than evaluations usually seen nowadays on the Internet such as evaluation voting by users and viewers (voting for “I like it”, for example). This is because a decision to resell is indeed evaluating the value, and how the reseller profits from reselling depends on their evaluations. In the case where a viewer is planning to produce secondary digital product, the viewer can obtain revenue from selling the secondary product by buying the primary digital product and then producing the secondary digital product and listing it on the market. In addition, the viewer can obtain legitimate profits from reselling yielded by the primary product whose resell price has been raised in conjunction with sales of the secondary digital product. Therefore, digital products are automatically and dynamically priced to fair prices reflecting demand from participants for the digital products, which facilitates distributions of digital products in the digital product electronic commerce market managed by the commerce management device. Since the value of a digital product fluctuates with the change in net quantity of sales of referrers, secondary digital products will more often be derived from primary digital products. Consequently, supply chains or value chains of digital products will form by, for example, creating further derivative digital products from such digital products that have been derived. Although the pricing method does not assure a seller to earn necessary or sufficient revenue equivalent for the investment in the development of a digital product, it is probable that the investment can be recovered and a costs for development of the next digital product can be financed if the seller produces and sells a digital product in good demand and the digital product reproduces a large number of secondary digital products, enhancing digital product development.

### BRIEF DESCRIPTION OF DRAWINGS

FIG. 1 is a schematic configuration diagram illustrating a commerce system that has a commerce management device according to an embodiment of the present disclosure;

FIG. 2 is a sequence diagram illustrating operations of the commerce system according to the embodiment;

FIG. 3 is a sequence diagram illustrating operations of the commerce system according to the embodiment;

FIG. 4 is a block diagram illustrating the commerce management device according to the embodiment;

FIG. 5 is a diagram illustrating products of a product database according to the embodiment;

FIG. 6 is a diagram illustrating products of accounts payable and accounts receivable database according to the embodiment;

FIG. 7 is a diagram showing a correlation between the price of product and the net quantity of sales obtained by subtracting the resell order count from the quantity of sales according to the embodiment; and

FIG. 8 is a flowchart illustrating an example operation flow of a digital product buy process performed by the commerce management device according to the embodiment.

### DESCRIPTION OF EMBODIMENTS

A digital product commerce management device according to one embodiment of the present disclosure will now be described in detail with reference to the drawings.

The digital product commerce management device (hereinafter called the “commerce management device”) according to the present embodiment is a device for managing exchanges of paid digital products among multiple members (participants) participating in an electronic commerce market for digital products, where the paid digital products are produced by the individual participants. In other words, the commerce management device is a device for managing commerce of digital products. Digital products are defined as digital data that are stored in a digital storage connected to a computer or any other digital information processing devices, are able to be transferred to an information terminal via network, and are used on the information terminal to which the digital products are transferred. Such a digital product is characterized in that specific product therein is neither deteriorated nor modified (unless willfully deteriorated or modified) when the digital product is stored in a storage, transferred via digital network, and reproduced or used on an information processing device, and that the cost of the storage, transfer, and reproduction is regarded as zero. Examples of such digital products may include image data, sound data, text data, numerical data, and software for research and development of science and technology. The image data encompass both full-motion video and still images. The text data include documents relating to research and development of science and technology. The numerical data encompass those which are used for creating graphs and tables. The software includes applications for various numerical analyses, simulations, visualization of numerical data with computer graphics, as well as software tools such as digital data editors and compilers for programing languages. Business plans or proposals including research and development plans and product plans also constitute digital products and are included in exchanged items to the extent that they are in the form of electronic (digital) data (tangible embodiments like mock-ups are excluded).

Digital products may further include what are called dynamic (web) pages, such as the pages that changes depending on who accesses the digital product or how the pages are accessed or the pages that provides computing services. In these cases, digital products include not only static data stored in the server storage but also dynamic data that changes every time when accessed. Therefore, the commerce management device can also be used for managing transactions of the right to use an online game played by multiple users on the network. Digital products can be provided by monitoring cameras or certain measuring devices. For example, the commerce management device can be employed for distributing images taken by a camera mounted on a high-quality large telescope for astronomical observation.

As described later, the commerce management device is highly relevant to crowdfunding by serving as a management device for securities exchange in which business plans are regarded as securities. The commerce management device is connected via network to information terminals each owned by each participant in the electronic commerce market managed by the commerce management device. The participants use their own information terminal to conduct commercial transactions of digital products with one another using the commerce management device.

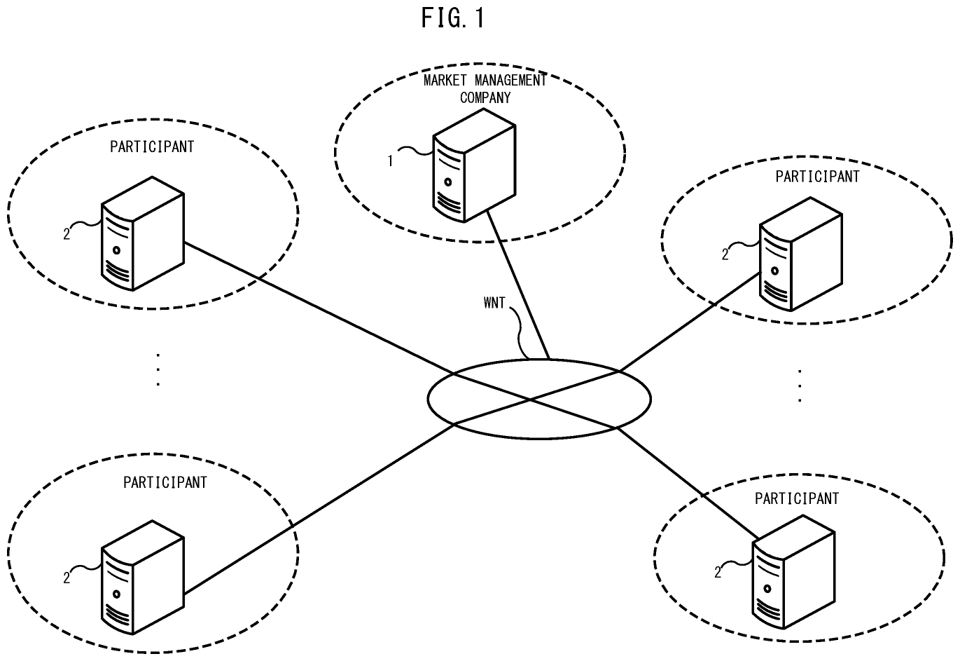

As illustrated in FIG. 1, a commerce management device, 1, is connected by a network, WNT, to an information terminal, 2, owned by an individual participant in the digital product electronic commerce market managed by commerce management device 1. Commerce management device 1 is implemented as a daemon process running on a server (hardware) for the digital product commerce management device. On information terminal 2, a client program (an Internet browser or an application having a user interface and network communication functions similar to those of browsers) is running for each participant in the digital product commerce market. Commerce management device 1 is installed in a market management company managing the electronic commerce market. Network WNT is made up of networks that include the Internet and local area networks (LAN) interconnected using the communication protocol such as Transmission Control Protocol/Internet Protocol (TCP/IP). Each participant can exchange various types of digital products by using information terminal 2, and is allowed to view or use the digital products that the participant has bought by payments through the transaction.

Note that commerce management device 1 can be distributed over multiple computers connected to network WNT. Faster transaction processing is achieved by daemon programs each running on each of distributed multiple computers and performing the processing in parallel. In this case, each of multiple computers may perform function-specific operations, such as those specialized in the transactions among participants in the market or those specialized in management of accesses to distributed digital products. For security purposes, a special network protocol other than existing protocols might be employed for such distributed processing. However, for the sake of simple explanations, the following descriptions assume that commerce management device 1 is running on a single computer. Then, almost all of the transactions are centrally performed within a single computer, and thus security problems are unlikely to occur as long as such a single computer is connected to external network WNT at a certain security level.

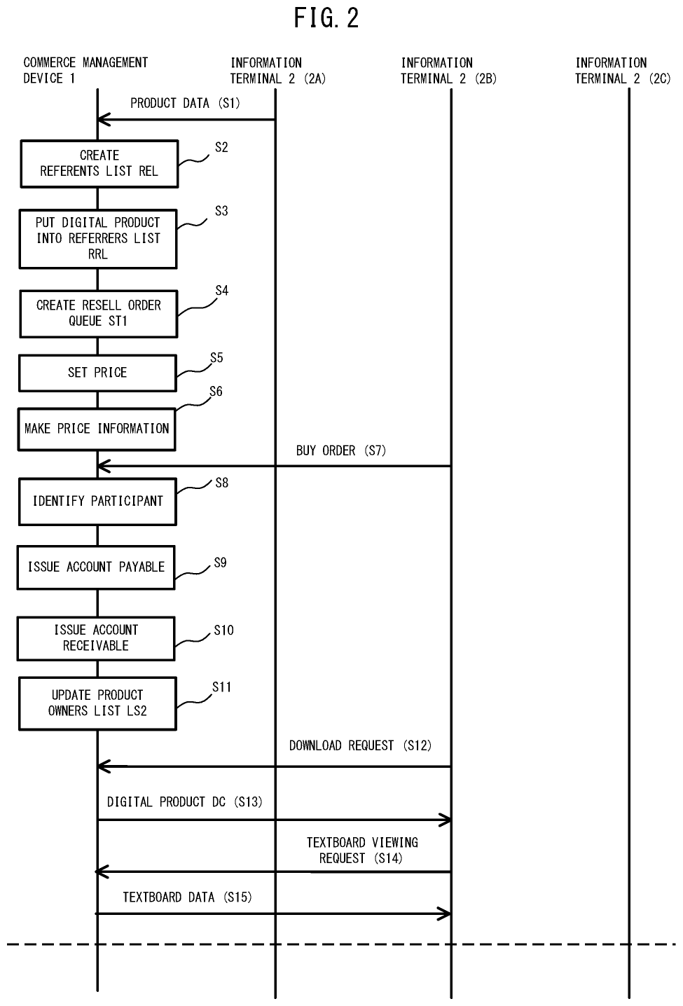

Referring to FIG. 2, the following describes operations of the digital product commerce system that consists of commerce management device 1 and information terminals 2 each owned by each of multiple participants. FIG. 2 illustrates digital product commerce among three participants who own the information terminals, 2A, 2B, and 2C, respectively.

Each participant using commerce management device 1 is given each participant identification number, and the participants hold their respective accounts created on the server on which a daemon process for commerce management device 1 is running. Each account is associated with each participant by the participant identification number. It is assumed here that participant A owning information terminal 2A has created a new digital product, digital product DC. When participant A performs, on information terminal 2A, an operation for sending digital product DC to commerce management device 1, the product data including digital product DC are sent from information terminal 2A to commerce management device 1 (step S1). The digital data regarding digital product DC include digital product DC itself, advertisement information directed to potential buyers of digital product DC, referents list REL, which is a list of digital products that digital product DC refers to, and referrers list RRL, which is a list of digital products that refer to digital product DC. Upon reception of the product data regarding digital product DC, commerce management device 1 gives a product identification number for the identification of digital product DC to the received product data regarding digital product DC so as to manage the product data regarding digital product DC in association with the product identification number of digital product DC. The product identification number of digital product DC is made up of the participant identification number for identifying participant A who produced digital product DC and listed it on the commerce market, and a unique identification number (serial number) given to each digital product produced by participant A in chronological order of production. Thus, all digital products listed on the market have an identification number representing which participant in the market has produced them. Note that each digital product is allowed to be updated by the participant who produced it at any time, but the original identification number of the digital product remains unchanged irrespective of any update. When a producer updates some existing digital product to deliberately form a new digital product, a new identification number may be given to the new digital product. However, it is meaningless and thus prohibited to give a new identification number to a dead copy of the original digital product.

Next, commerce management device 1 creates referents list REL of digital product DC (step S2). Then, commerce management device 1 additionally puts digital product DC into referrers list RRL of each digital product in referents list REL (Step S3).

Note that referrers list RRL of digital product DC is empty at the beginning. If the producer of digital product DC revises referents list REL, deletion or addition of a digital product to or from referents list REL takes place respectively. If this is the case, deletion or addition of a digital product from or to referents list REL updates referrers list RRL of those product that are deleted from or added to referents list REL of digital product DC, by deleting or adding digital product DC to or from referrers list RRL of that product.

Next, upon reception of the product data regarding digital product DC, commerce management device 1 creates a resell order queue ST1, (step S4). Immediately after digital product DC is listed (posted), resell order queue ST1 is empty. Thereafter, when digital product DC is sold once to a buyer and then it is resell-ordered by that buyer, the identification number of the buyer who resell-orders is added to resell order queue ST1 of digital product DC. Because resell order queue ST1 is a last-in, first-out stack, the resell order put into the list last is removed first from resell order queue ST1, when the transaction of the order is contracted.

Next, commerce management device 1 creates transaction log LS1 for digital product DC. Transaction log LS1 of digital product DC is an accumulation of transaction forms each of which describes who sold what digital product to whom at what price in the transaction. Accordingly, each transaction form contains the seller's participant identification number, the buyer's participant identification number, and the price of the digital product. From transaction log LS1, the quantity of sales of digital product DC is calculated, where the quantity obtained by subtracting the latest quantity of sales where the producer was the buyer from the latest quantity of sales where the producer was the seller, and the quantity of resale (the latest quantity of resell transactions where a non-producer was the seller). It is meaningless and thus is prohibited to conduct such a transaction where the participant who sells is identical to the buyer.

Next, commerce management device 1 sets a price P of digital product DC, which has been received from information terminal 2A and newly listed on the market (step S5). For those newly listed digital products, the quantity of sales is zero, the resell order count is zero, and thus the net quantity of sales is zero at the beginning. Also referrers list RRL is empty for those newly listed digital products because those digital products have not yet been referred to by any other digital products. Accordingly, any quantity of sales of their referrers is zero. The initial price, which is the transaction (sell) price for the initial buyer of the digital product that has just been listed, is determined by employing a pricing function, where both of the quantity of sales and the net quantity of sales are zero for the digital product that has just been listed, and each net quantity of sales of its referrers is also zero, for referrers list RRL is empty. A while after the digital product is listed, at least one of the quantity of sales, the resell order count, and the net quantities of those products in the referrers list are unlikely to be zero. Thus, a while after the digital product is listed, a price of the digital product is set by using the pricing function that takes, as arguments, the quantity of sales, the resell order count, and the net quantities of sales of products in its referrers list, when the price is set.

Commerce management device 1 makes the price information indicating the price of digital product DC whose price has been set, available for (or made public to) those individual information terminals, 2A, 2B, and 2C (step S6). Along with the price information regarding digital product DC, commerce management device 1 makes accessible the advertisement information directed to potential buyers of digital product DC from those individual information terminals, 2A, 2B, and 2C. Hence, advertisement information and prices of all those listed digital products are known to all participants. It is desirable that a trend in price of each digital product since the initial listing is made available if necessary.

Participant B owning information terminal 2B, now desires to buy digital product, DC. Then, participant B uses terminal 2B to select a desired digital product (DC) among digital products whose price and advertisement information are available, and sends a buy order for digital product DC to commerce management device 1 (step S7). In the case of multiple transactions occurring within a short period of time for a single digital product, the price may be different from the price displayed when B, who is going to buy that digital product, accesses the price information. Commerce management device 1 gives weight and higher priority to the effective price at the time when a transaction is contracted than to the price last confirmed by the participant who is going to buy it. Hence, commerce management device 1 is required to keep records of transactions and resell order queue ST1 of individual digital products under strict time-series management and to accurately handle queues so as not to lose or duplicate any transactions.

Next, commerce management device 1 identifies which participant is to sell or resell digital product DC to participant B, who desires to buy digital product DC (step S8). As is described above, the participant who resell-ordered the digital product last among those in resell order queue ST1 is determined to be the seller; or, in the case of empty resell order queue ST1, participant A, who produced digital product DC and listed it on the market is determined to be the seller. After determined, the resell order added last is removed from resell order queue ST1 (since resell order queue ST1 is a last-in, first-out stack, when the last resell order is taken out from resell order queue ST1, the resell order is deleted from resell order queue ST1).

Next, commerce management device 1 issues an account payable (step S9). An account payable is a form of digital information that contains the participant identification number of the seller (participant A or the issuer of the resell order form), the participant identification number of the buyer (participant B), the identification number of digital product DC, and the price (or resell price) of digital product DC, with participant B's digital signature affixed. The account payable is added to the last in received accounts payable list LS13 in the seller's account, and is also added to the last in issued accounts payable list LS11 of the buyer (participant B), and is further added to the last in the full accounts payable list of the market manager. The identical account payable is preserved by three parties: the seller, the buyer, and the market manager, and thus checking the accounts payable among those preserved by the three parties can easily reveal any unauthorized alteration or deletion in the account payable, thereby repressing unauthorized manipulations of transaction records.

Next, commerce management device 1 issues an account receivable (step S10). An account receivable is a form of digital information that contains the participant identification number of the seller (participant A or resell order form issuer), the participant identification number of the buyer (participant B), the identification number of the digital product, and the price of the digital product, with the seller's digital signature affixed. The account receivable is added to the last in issued accounts receivable list LS12 in the seller's account, and is also added to the last in received accounts receivable list LS14 of the buyer (participant B), and is further added to the last in the full accounts receivable list of the market manager. The identical account receivable is preserved by three parties: the seller, the buyer, and the market manager, and thus checking the accounts receivable among those preserved by the three parties can easily reveal any unauthorized alteration or deletion of the account receivable, thereby repressing unauthorized manipulations of transaction records. In addition, since the identical product identification number is shared by both of the account payable and account receivable, comparison of the two accounts (payable and receivable) further represses unauthorized manipulations of transaction records. In parallel with these operations, commerce management device 1 adds to transaction log LS1 of digital product DC, a transaction form containing the participant identification number of the seller (or reseller), the participant identification number of the buyer, and the transaction price.

Note here that the transaction (sell, resell, or buy) price described in an account receivable and an account payable is not a currency-based price but the price expressed by the below-mentioned equations (1) to (6), which take the net quantities of sales as arguments, without the currency rate. In view of rolling out commerce management device 1 of the present disclosure worldwide in future, a price in a currency used in a particular country or region is not suitable as an international transaction price because currency values differ from each other in different countries and regions. Hence, a transaction price (regarded as an internal price) is represented by a mathematical function that takes, as arguments, the net quantities of sales yet without currency exchange rate, and then the account is later settled in a particular currency by multiplying the internal price by a currency exchange rate applied to the currency. For the settlement, the exchange rate may differ depending on the direction of account settlement as seen in foreign exchange. For example, it is allowed to settle the account in such a way that the exchange rate is 90 yen per internal unit when the internal price is exchanged to the price in Japanese yen whereas the exchange rate is 110 yen when the price in Japanese yen is exchanged into the internal price.

Furthermore, subject to permission granted by the manager of commerce management device 1 or an operator, a currency exchange market should be provided to the participants to carry out exchanges between an internal price and the price in a currency based on prevailing market prices.

Next, commerce management device 1 updates product owners list LS2 of digital product DC by adding participant B to product owners list LS2 (step S11). In this step, participant B is permitted to access digital product DC that participant B has bought.

Now, suppose that participant B, who bought digital product DC, has performed on information terminal 2B an operation for downloading digital product DC to information terminal 2B from commerce management device 1. Then, the download request for obtaining digital product DC is sent to commerce management device 1 from information terminal 2B (step S12). The download request contains the participant identification number of the participant who owns information terminal 2B as well as the keycode for accessing digital product DC. Upon reception of the download request, commerce management device 1 searches participant B's participant identification number for product owners list LS2 of digital product DC. If B's participant identification number is found in product owners list LS2 of digital product DC, participant B's access to digital product DC is approved and digital product DC is sent from commerce management device 1 to information terminal 2B (step S13). The transferred data of digital product DC is encrypted in such a network transfer protocol supporting security, as TLS (SSL) or SSH.

Now, suppose that participant B, who obtained the keycode for accessing digital product DC, has performed on information terminal 2B an operation for viewing the textboard pertaining to digital product DC managed by commerce management device 1. The textboard view request for viewing the textboard of digital product DC is sent to commerce management device 1 from information terminal 2B (step S14). The textboard view request contains the participant identification number of the participant who owns information terminal 2B as well as the keycode for accessing digital product DC. Upon reception of the textboard view request, commerce management device 1 searches, as with the downloading digital product DC described above, participant B's participant identification number for product owners list LS2 of digital product DC. If it is confirmed that participant B is the legitimate owner of digital product DC, the textboard data is sent from commerce management device 1 to information terminal 2B (step S15).

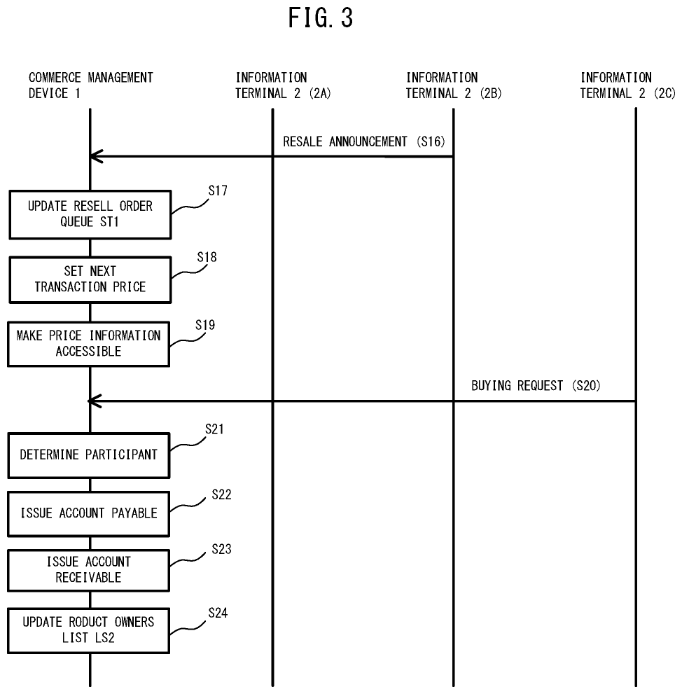

It is assumed here that participant B, who has bought digital product DC, desires to resell it (digital product DC). When participant B performs on information terminal 2B an operation for sending to commerce management device 1 a resell order that participant B desires to resell digital product DC, the resell order is sent from information terminal 2B to commerce management device 1 as indicated in FIG. 3 (step S16). A resell order for digital product DC by a participant who neither has bought nor owned that digital product DC is equivalent to a short selling in the stock exchange market. If such reselling is permitted, the net quantity of sales obtained by subtracting the resell order count from the quantity of sales could be negative. Therefore, it is desirable, as a general rule, to prohibit participants other than the owner of digital product DC to issue a resell order form to resell digital product DC. In other words, the only those owners of digital product DC are allowed to issue resell order form of digital product DC, and, for every resell order form, it is desirable to confirm whether the issuer is actually the owner of the product before approving the resell order. The ground for this is that, whereas securities can be borrowed with or without charge in the stock exchange where the number of issued securities is fixed, digital product cannot be borrowed in the commerce of digital products because the quantity of sales (which is equivalent to the number of issued securities) increases.

Upon reception of the resell order which is sent from information terminal 2B owned by participant B, commerce management device 1 updates resell order queue ST1 of digital product DC by adding participant B to the resell order form issuers of digital product DC (step S17). As described above, this means that participant B's participant identification number is added to the top of resell order queue ST1. Accordingly, when a buyer of digital product DC emerges before any other participant issues a subsequent resell order form for digital product DC, participant B, who is enqueued at the top of resell order queue ST1, is determined to be the participant to resell digital product DC, and participant B is deleted from resell order queue ST1 when the resell transaction is contracted. Note that a resell order may be cancelled at any time after the resell order form is issued and enqueued. After a resell order form of a certain digital product is issued, as long as no other resell order previous to that order is cancelled, the price effective when the reselling is contracted is determined according to a pricing method employed by commerce management device 1. When any other resell order form issued by other participants prior to that resell order is cancelled, the price rises. In order to maintain this, those digital products which undergo frequent resell orders, or whose prices are plummeting, have to keep waiting for a long time until the resell transaction is contracted. On the other hand, if a resell order is cancelled and a resell order form is immediately issued again, the resell order will be contracted in a shorter time but the price must be lower than that before cancelling. Such mechanism of cancelling resell order prevents the price of digital product of lower demand from plummeting. In the case of a participant resell-ordering a single digital product multiple times and then cancels some of these resell orders, it is desirable to sequentially cancel the resell orders starting from the last one.

Then, commerce management device 1 sets the price in the next transaction of digital product DC, based on the quantity of sales and the resell order count of digital product DC managed by commerce management device 1 as well as on the net quantities of sales of its referrers in referrers list RRL (step S18). In this step, commerce management device 1 sets the price of the digital product by employing a predefined pricing function. The pricing function herein is a function that returns a transaction price of digital product DC by taking, as arguments, the net quantity of sales obtained by subtracting the resell order count from the quantity of sales of the digital product, and each net quantity of sales of its referrers. The pricing function is a monotonically increasing function that increases with the increase in the net quantity of sales of digital product DC itself and in each net quantity of sales of its referrers. Thus, for example, the transaction price of digital product DC determined when the quantity of sales is 3 and the resell order count is 0 is equal to the transaction price of digital product DC determined when the quantity of sales is 5 and the resell order count is 2, as long as each referrer's net quantity of sales remains unchanged.

Then, commerce management device 1 makes public to all the participants, the price information indicating the price that has been set for digital product DC, allowing the information terminals, 2A, 2B, and 2C to access the price information (step S19). However, the information does not include who is the provider (seller) of the digital product. This it is not disclosed to any of the information terminals, 2A, 2B, and 2C, whether the digital product is provided by the producer of the digital product or provided through reselling. Thus, the participants who own the information terminals, 2A, 2B, and 2C do not directly know whether the digital product they are going to buy is provided by the producer of the digital product or by a reseller. However, price fluctuations previous to the purchase are disclosed, and thus it is presumed that the digital product will be sold by reseller if the price is lower than the all-time highest, whereas it is presumed that the digital product will be sold by the producer (participant A) if the price is the all-time highest. Needless to say, who is selling the digital product is revealed at the time of a contract because the account payable and the account receivable each containing the identification number of the seller are exchanged at the time of contract.

Suppose here that participant C owning information terminal 2C desires to buy the digital product after its price has been notified. When participant C performs on information terminal 2C an operation for sending to commerce management device 1, a buy order for buying the digital product whose price has been notified, the buy order is sent from information terminal 2C to commerce management device 1 (step S20).

Next, commerce management device 1 determines the participant to resell the digital product to participant C who desires to buy the digital product (step S21). As described above, in this step, the resell order form issuer listed at the top of resell order queue ST1 of that digital product is determined to be the participant to resell the digital product, and then that order by the issuer at the top of resell order queue ST1 is removed. When resell order queue ST1 is empty, the producer is determined to be the seller. In the example in FIG. 2, commerce management device 1 determines participant B to be the provider of the product. Next, commerce management device 1 issues an account payable (step S22). The account payable is a form of digital information that contains the participant identification number of the seller (participant B or resell order form issuer), the participant identification number of the buyer (participant C), the identification number of the digital product transacted, and the price of the digital product in the transaction, with the digital signature of participant C, the buyer, affixed. The account payable is added to the last in received accounts payable list LS13 in the account of the seller, and is also added to the last in issued accounts payable list LS11 of the buyer (participant C), and is further added to the last in the full accounts payable list of the market manager. Commerce management device 1 then issues an account receivable (step S23). The account receivable is a form of digital information that contains the participant identification number of the seller (participant B or resell order form issuer), the participant identification number of the buyer (participant C), the identification number of the digital product transacted, and the price of the digital product with the seller's digital signature affixed. The account receivable is added to the last in issued accounts receivable list LS12 in the account of the seller, and is also added to the last in received accounts receivable list LS14 of the buyer (participant C), and is further added to the last in the full accounts receivable list of the market manager.

Next, commerce management device 1 updates product owners list LS2 by deleting participant B, who resells the product, from product owners list LS2 (step S24). A participant who listed digital product DC on the digital product transaction market operated by commerce management device 1, namely participant A who produced digital product DC, is permitted to buy that digital product DC. However, when the resell order count is zero, such buying (transaction from participant A to participant A) is meaningless and thus prohibited. When the resell order count is not zero, the digital product is resold to the producer by the participant who resell-ordered last, and the quantity of sales decreases by 1. Specifically, when the quantity of sales is calculated based on the transaction log of digital product DC, the quantity of sales after the latest transaction in which the producer was the buyer is subtracted from the quantity of sales of digital product DC produced by the seller.

As described above, by using the digital product commerce system according to the present disclosure, each participant of the digital product electronic commerce market can distribute paid digital product produced by a participant to other participants. Furthermore, after buying a digital product, each participant can resell the purchased digital product to other participants.

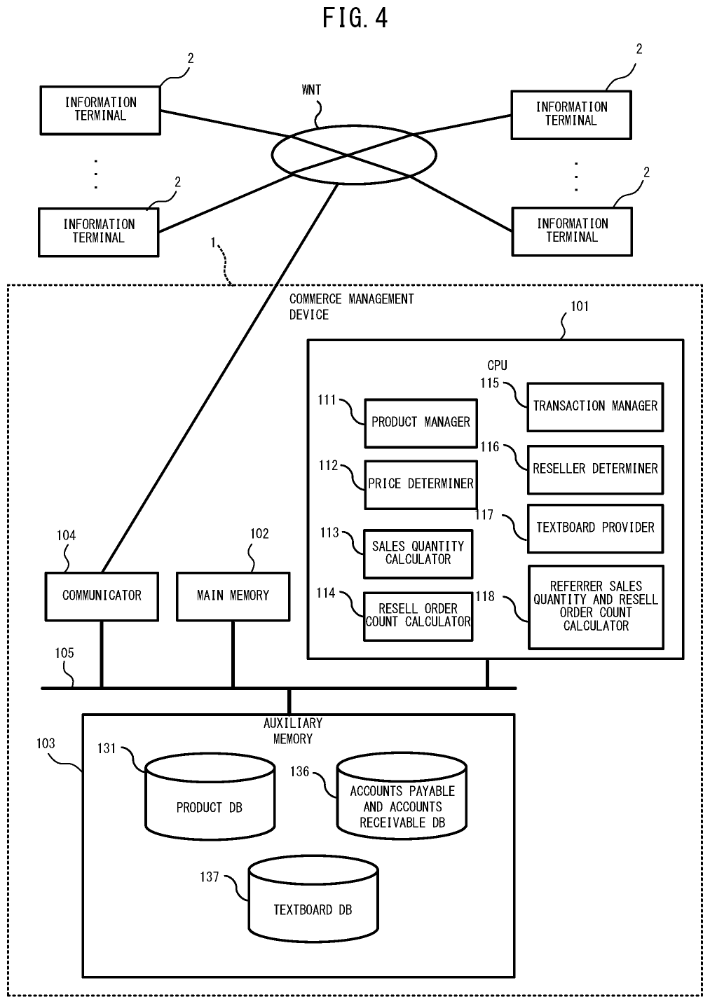

The following describes a hardware configuration of commerce management device 1 according to the present embodiment. Commerce management device 1 may be implemented on, for example, a general-purpose computer such as a personal computer, and may be comprised of a central processing unit (CPU) 101, a main memory 102, an auxiliary memory 103, a communicator 104, and a bus 105, which connects the components to one another, as illustrated in FIG. 4. Main memory 102 is a volatile memory such as random-access memory (RAM) and is used as a work area for CPU 101. Auxiliary memory 103 is a non-volatile memory such as a magnetic disk or a semiconductor memory and stores programs and various parameters for performing the commerce management process described below. CPU 101 runs the commerce management process described below by reading a program stored in auxiliary memory 103 into main memory 102 and executing the program. Communicator 104 is connected to network WNT to transform information received via network WNT and transfers the resulting information to bus 105.

The following describes a functional configuration of commerce management device 1 according to the present embodiment. By reading a program stored in auxiliary memory 103 into main memory 102 and executing the program, CPU 101 functions as a product manager (resell order manager) 111, a price determiner 112, a sales quantity calculator 113, a resell order count calculator 114, a transaction manager 115, a reseller determiner 116, a textboard provider 117, and a referrer sales quantity and resell order count calculator 118. Auxiliary memory 103 records a product database (DB) (product storage) 131, an accounts payable and accounts receivable DB (account payable storage and account receivable storage) 136, and a textboard DB 137.

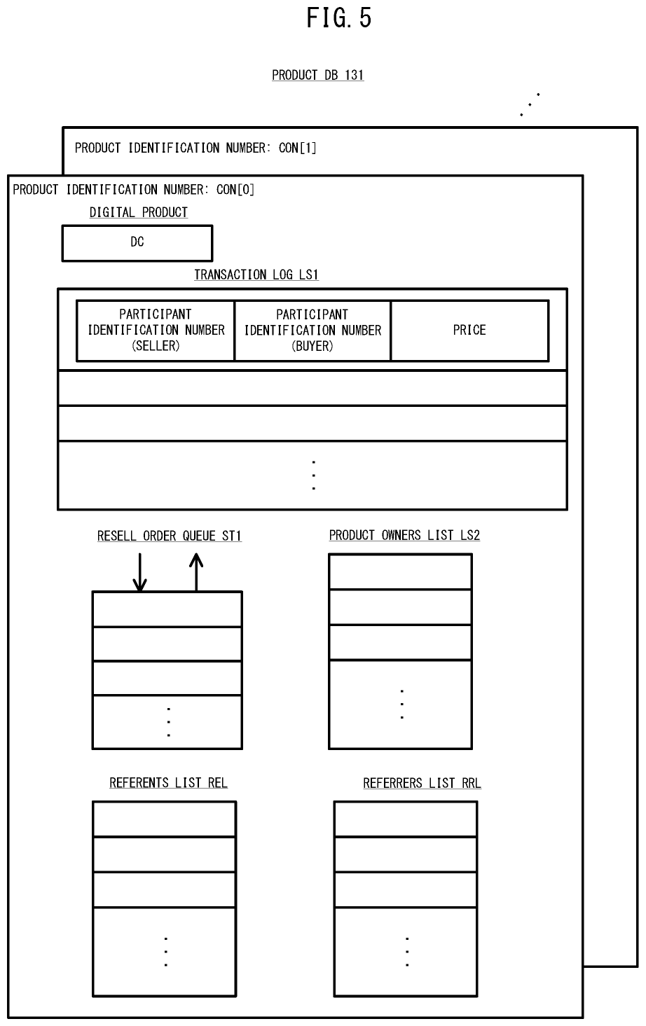

As in the example illustrated in FIG. 5, product DB 131 stores a digital product created by a participant, a transaction log LS1 (transaction log storage), a resell order queue ST1 (resell order storage), a referents list REL (referent products storage), and a referrers list RRL (referrer product storage), all of which are associated with the product identification number for identifying a digital product. The product identification number is a combination of a participant identification number identifying the participant who produced the digital product and a unique identification number given to every digital product produced by the participant in chronological order of production. Each digital product is encrypted, compressed and then stored in product DB 131 except for virtualized digital product such as streaming product, which is described below. Some digital products may be virtualized files representing movie and sound data for streaming purposes such as live streaming. Referents list REL is a list of other digital products referred to (or cited) by digital product DC, whereas referrers list RRL is a list of other digital products that refer to (or cite) digital product DC. In addition, product DB 131 stores relevant information including, for example, the title, abstract, and summary of the digital product, a revision history, comments or evaluations made by participants who recommend the digital product, or a list of those owners who have bought at least a certain base quantity of digital product DC (a list of sponsors). Part of the relevant information may be created by the participant who produced the digital product, whereas part of the relevant information may be added after digital product DC is listed on the market for sale. Such relevant information includes advertisement information intended to encourage those participants who have not yet bought it to buy the digital product.

Transaction log LS1, which every digital product is equipped with, is a log of transactions involving the digital product accumulated in chronological order, where each transaction form contains the participant identification number of the seller, the participant identification number of the buyer, and the price of the digital product in that transaction that are associated with one another.

Resell order queue ST1 is a last-in-first-out stack of participant identification numbers of the participants who have resell-ordered the digital product. If a participant issues a resell order form twice or more for an identical digital product, the identification number of the participant is enqueued twice or more into the queue of that digital product.

Product owners list LS2 is a list of participant identification numbers of the participants who bought the digital product.

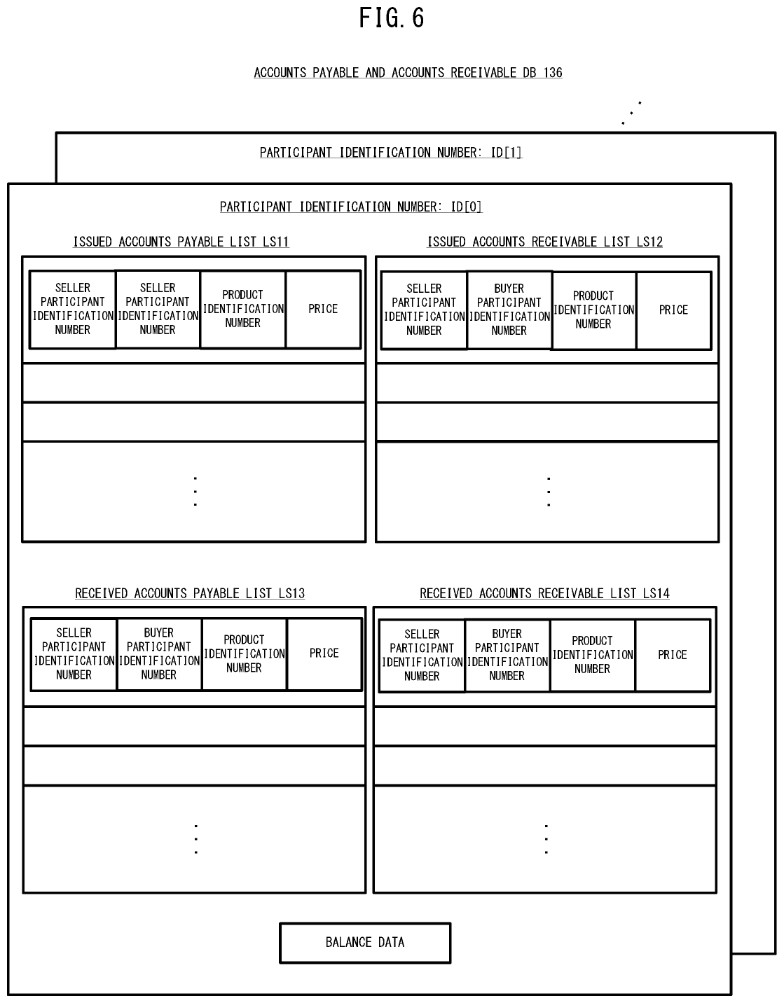

Accounts payable and accounts receivable DB 136 of each participant, as illustrated in the example in FIG. 6, consists of issued accounts payable list LS11, issued accounts receivable list LS12, received accounts payable list LS13, and received accounts receivable list LS14. Issued accounts payable list LS11 exactly matches received accounts payable list LS14. And also issued accounts receivable list LS12 exactly matches received accounts payable list LS13. The transaction balance of the participant is the amount obtained by subtracting the sum of transaction prices over all accounts in issued accounts payable list LS11 from the sum of transaction prices over all accounts in issued accounts receivable list LS12. Issued accounts payable list LS11 is a list which accumulates in chronological order, those issued accounts payable each representing an account payable issued by the participant who is the buyer in each transaction. An issued account payable contains the seller's participant identification number (the seller may be a reseller), the buyer's participant identification number, the product identification number, and the price of the digital product. Each issued account payable is added to issued accounts payable list LS11 with a digital signature affixed by using the private key of the buyer with RSA encryption, elliptic curve cryptosystem, or the like. Issued accounts receivable list LS12 is a list which accumulates in chronological order, those accounts receivable each representing an account receivable by the participant, who is the seller (or reseller) in each transaction. An issued account receivable also contains the seller's participant identification number, the buyer's participant identification number, the product identification number, and the price of the digital product. Each issued account receivable is added to issued accounts receivable list LS12 with a digital signature affixed by using the private key of the seller (who may be a resell order form issuer) with RSA encryption, elliptic curve cryptosystem, or the like. Received accounts payable list LS13 is a list which accumulates in chronological order, those received accounts payable each representing an account payable received by the participant in each transaction. A received account payable contains the seller's participant identification number (the seller may be a reseller), the buyer's participant identification number (the buyer is the participant who issued the account payable), the product identification number, and the price of the digital product. Received accounts receivable list LS14 is a list which accumulates in chronological order, those received accounts receivable each representing an account receivable received by the participant in each transaction. A received account receivable also contains the seller's participant identification number (the seller is the participant who issued the account receivable and may be a reseller), the buyer's participant identification number, the product identification number, and the price of the digital product. As described above, the transaction balance for each participant is the amount obtained by subtracting the sum of transaction amounts over all accounts payable from the sum of transaction amounts over all accounts receivable of the participant. Each participant can download any time a list of accounts payable and a list of accounts receivable of that participant to check the transaction log, and these lists can be used as transaction statements required for taxation purposes.

Textboard DB 137 stores the textboard data needed for a textboard to provide to the participants who are permitted to access the product stored in product DB 131. The textboard data provide a textboard on which the producer and owners of the digital product thereof are exclusively permitted to read and write, as well as data (like textboard logs) pertaining to the textboard.

Referring back to FIG. 4, when product manager 111 receives product data from information terminal 2 owned by a participant, product manager 111 stores the digital product including the product data into product DB 131. In addition, product manager 111 creates resell order queue ST1, of the digital product obtained from information terminal 2, and stores resell order queue ST1 into product DB 131. The participant identification number of the participant who owns information terminal 2 that produced the product data is registered as the producer of the product to resell order queue ST1 created by product manager 111. Furthermore, product manager 111 transfers the digital product to information terminal 2 from which a download request has been sent. Before transferring the digital product, product manager 111 encrypts the digital product. As a rule, product manager 111 transfers the latest version of the digital product stored in product DB 131. However, if the digital product is frequently revised and updated, product manager 111 may provide another previous version if necessary.

Sales quantity calculator 113 calculates the quantity of sales based on transaction log LS1, which is stored in product DB 131, for a digital product produced by a participant in the electronic commerce of digital product. As described above, the quantity of sales as used herein refers to a number obtained by subtracting the actual number of transactions in which the buyer is the producer of the digital product (or a participant who has listed the digital product on the market) from the actual number of transactions in which the seller is the producer of the digital product (or a participant who has listed the digital product on the market).

Resell order count calculator 114 calculates the resell order count based on resell order queue ST1, which is stored in product DB 131 and contains resell order forms for that digital product issued by participants.

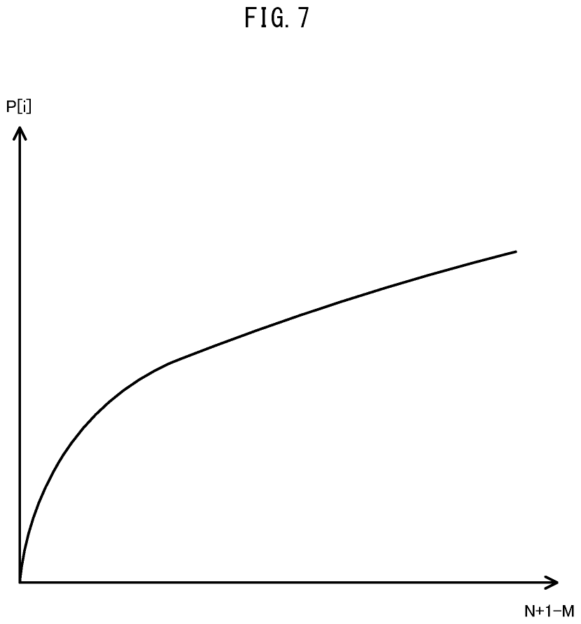

Price determiner 112 starts with obtaining the quantity of sales calculated by sales quantity calculator 113 for each digital product and the resell order count calculated by resell order count calculator 114. Then, price determiner 112 employs a predefined pricing function to set the price of each digital product from quantity of sales and the resell order count that have been obtained. The price to be made available here is the price in the next transaction, which is calculated by employing a pricing function that takes, as arguments, the net quantity of sales that is obtained by subtracting the resell order count from the latest quantity of sales (as calculated in the foregoing manner) and each net quantity of sales of the referrers in referrers list RRL. The pricing function as used herein is a function that returns the price of a digital product by taking, as arguments, the net quantity of sales obtained by subtracting the resell order count from the quantity of sales of the digital product, and each net quantity of sales of referrers in referrer list RRL. The pricing function is a monotonically increasing function that monotonically increases with the increase in the net quantity of sales. The price of digital product as determined by price determiner 112 is solely dependent on the net quantity of sales and each net quantity of sales of the referrers, without regard to the specific products, size, or usefulness of digital products. Therefore, the price of digital product rises when the net quantity of sales of the digital product increases. The price of a digital product also rises when some net quantities of sales of its referrers increase. In other words, the value of digital product goes up. Price determiner 112 determines the price of digital product by employing a pricing function that shows, for example, a correlation illustrated in FIG. 7. The followings describe how a pricing function is defined.

In cases where the quantity of sales of a digital product and the resell order count for the digital product are only taken into consideration, the price of the digital product is given by the following equation (1):

[Math 1]

P=K log₂(N−M+2) Equation (1)

where P is the price of the digital product, N is the quantity of sales of the digital product, M is the resell order count of the digital product, and K is the exchange rate for converting into a price in a particular currency used for settlement of the transaction. In the equation (1), 2 is added to the argument of the logarithm so that the initial sales price is equal to K when the net quantity of sales is 0, that is the case when the sales has just started.

The foregoing equation (1) is derived based on the theory described below. In the digital product electronic commerce market, the number of states where digital product DC is owned only by participant A, who produced the digital product, and the number of states where digital product DC is additionally owned by N other participants, which are the states where digital product DC is owned by (N+1) participants (1 for the producer is added) are considered. Applying the concept of equilibrium state in chemical reactions, the equilibrium constant for the transaction state above is then, given as K_{Eq}=(1+N)/1. The natural logarithm, ln (1+N), of the equilibrium constant K_{Eq} is a free entropy difference in a chemical reaction (where the Boltzmann constant is 1), and can be regarded as a value representing the marketability of the digital product, that is, the value of the digital product. In other words, the value of digital product is considered a dimensionless free entropy difference described above, ΔΞ. Therefore, the value of digital product is conceivably proportional to the dimensionless free entropy difference ΔΞ=ln (N+1). In the present embodiment, the value is expressed in units of 1/ln (2). Then, the value of digital product is given by equation (2):

[Math 2]

V=log₂(N+1) Equation (2)

where V is the value of the digital product, and N is the quantity of sales (the quantity of sales plus the quantity in the next transaction, =1). The price P is then, P=KV, the value multiplied by the exchange rate K to convert into the price in a particular currency. The foregoing equation (1) is derived based on the idea that the quantity of sales apparent to the participant who produced the digital product, that is, the net quantity of sales (the net quantity of sales plus the quantity in the next transaction, 1), decreases by the resell order count of the digital product that the producer listed on the market. In other words, the pricing function is a logarithmic function to base 2 taking, as an argument, a number obtained by adding 1 to the quantity of sales, multiplied by an exchange rate for representing a value in a particular currency for settlement. In this way, the price of digital product is set to a fair price taking into considerations market principles underlying the digital product electronic commerce market.

As described above, in a transaction, the amount received by the party who receives the transaction amount (the seller or reseller) may not necessarily be equal to the amount paid by the party who pays the transaction amount (the buyer). In the case where the received amount is smaller than the paid amount, the difference may be commission fees paid to the manager who manages the commerce management device. On the other hand, when the received amount is larger than the paid amount, the difference can be considered a value created in the market by the transaction. For example, suppose that the received amount is calculated by equation (1) above, and the paid amount P is calculated by the following equation (3):

[Math 3]

P′=K log₂(N−M+1) Equation (3).

The value equivalent to the difference is created every time a transaction is contracted. In other words, a price reduction by discount is offered to the payer whereas a value equivalent to the amount of difference on average is created in market transactions. This means that profits are generated on average through purchases and resells of a single digital product, contributing to more active transactions.

Now, taking into considerations the effects of each net quantity of sales of the referrers on the transaction price of digital product DC, equation (1) is modified into the following equation (4). As seen below, each net quantity of sales of those referrers in referrers list RRL are added as each term to the arguments of the pricing function:

$$\begin{matrix}[ Math 4 ] & \\ P = K {log}_{2} [ {N}_{0} - {M}_{0} + 2 + {\sum }_{i = 1}^{I} ( {N}_{i} - {M}_{i} ) ] & Equation ( 4 )\end{matrix}$$

where N₀ is the quantity of sales of digital product DC, M₀ is the resell order count of digital product DC, and I is the number of referrers in referrers list RRL. Nᵢ and Mᵢ are the quantity of sales and the resell order count, respectively, of i-th referrer in referrers list RRL. N₁ and M₁ represent the quantity of sales and the resell order count, respectively, of the referrer at the first in referrers list RRL.

Note that the pricing function is not limited to that in equation (4) but may include, for example, following equation (5) or (6):

$$\begin{matrix} [ Math 5 ] & \\ P = K {log}_{2} ( {N}_{0} - {M}_{0} + 2 ) + K {log}_{2} [ {N}_{0} - {M}_{0} + 2 {+ \sum }_{i = 1}^{I} ( {N}_{i} - {M}_{i} ) ] & Equation ( 5 ) \\ [ Math 6 ] & \\ P = K {log}_{2} ( {N}_{0} - {M}_{0} + 2 ) + K {\sum }_{i = 1}^{I} {log}_{2} ( {N}_{i} - {M}_{i} + 1 ) . & Equation ( 6 )\end{matrix}$$

In the case of the pricing function in equation (4), the price of digital product DC rises not very sharply with the increase in the number of referrers. In contrast, in the case of the pricing function in equation (6), the price of digital product DC rises in proportion to the increase in the number of referrers. In the case of the pricing function in equation (5), the price of digital product DC rises in such a way between the two pricing functions, those in equation (4) and equation (6). As seen above, the increase in the number of referrers contributes to the rise in the price of product DC referred to by the referrers to a different extent depending on which equation, (4) to (6) is employed for the pricing function. Note that, however, once any one of those equations (4) to (6) is selected for the pricing function, the selected equation is kept being used for all the time, in order to assure fairness of transactions.

Transaction manager 115 stores into accounts payable and accounts receivable DB 136 of each participant, an issued account payable or an issued account receivable representing the account payable or the account receivable issued by the participant in a transaction respectively. Transaction manager 115 stores into accounts payable and accounts receivable DB 136 of each participant, a received account payable or a received account receivable representing the account payable or the account receivable received by the participant in a transaction. It is reminded here that, as described above, the transaction prices listed in the account receivable and the accounts payable lists are represented by one of the foregoing equations (1) to (6) without exchange rate K. It is further reminded here that the currency exchange rate K is allowed to differ depending on the direction of account settlement. Every time a digital product transaction is contracted, transaction manager 115 inspects consistency in each participant's forms by checking the difference between participant's issued accounts and received accounts, the issued account payable and issued account receivable, and the received account payable and received account receivable. Upon confirming consistency in each participant's issued account payable and issued account receivable and the participant's received account payable and received account receivable, transaction manager 115 generates balance data by calculating the difference between the sum of prices over issued accounts payable and the sum of prices over issued accounts receivable. Suppose that accounts payable and accounts receivable DB 136 stores a tremendously growing number of issued accounts payable, issued accounts receivable, received accounts payable, or received accounts receivable. In order to avoid a prolonged calculation of the balance data, transaction manager 115 splits the series of those issued accounts payable, issued accounts receivable, received accounts payable, or those received accounts receivable into a series of blocks once in every certain time period (one month, for example) to make a kind of a blockchain. The term “blockchain” here does not refer to such a blockchain where each block is approved with special number as in mining for Bitcoin and others but refers to merely splitting into blocks according to a certain amount and saving the resulting blocks (with the contained information compressed, as a rule).

After receiving an account payable from the participant who buy-ordered a digital product, transaction manager 115 put the participant identification number of the participant who buy-ordered the product into product owners list LS2 stored in product DB 131. Furthermore, when a transaction is contracted between a participant who resell-order the digital product and the participant who buy-ordered, transaction manager 115 deletes the participant identification number of the participant who resell-ordered from product owners list LS2. Note that transaction manager 115 causes resell orders to be contracted sequentially starting from the participant who last resell-ordered. When a participant has canceled a resell order, the transaction manager 115 deletes the participant's participant identification number from resell order queue ST1.

Reseller determiner 116 identifies the resell order form issuer who is willing to resell a digital product as the participant identification number in resell order queue ST1 of the product identification number of the target digital product as stored in product DB 131. Since resell order queue ST1 is a last-in-first-out stack accumulating participant identification numbers, when a buy order is received from information terminal 2 owned by a participant, reseller determiner 116 determines the reseller by identifying the participant identification number of the participant who resell-ordered last among the multiple participant identification numbers in resell order queue ST1. After reseller determiner 116 identifies a participant identification number, the number is deleted from resell order queue ST1.

Textboard provider 117 provides a textboard to participants by sending the textboard data obtained from textboard DB 137 to those information terminals 2 each owned by those participants whose participant identification number is found in product owners list LS2 of the digital product. In other words, textboard provider 117 provides a textboard exclusively to the producer and owners of the digital product who are allowed to read and write to it. Note that textboard provider 117 provides information about transitional change in the number of messages and access count on the textboard to all the participants including those who are neither the producer nor the owners of the digital product.

Referrer sales quantity and resell order count calculator 118 calculates the quantity of sales and the resell order count of each of referrers in referrers list RRL stored in product DB 131.

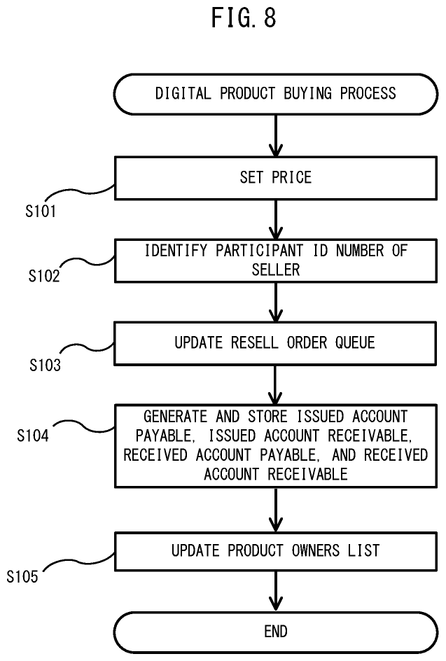

Referring to FIG. 8, the followings describe a digital product buy process performed by commerce management device 1 according to the present embodiment. The buy process of a digital product starts upon reception by commerce management device 1 of a buy order for a certain digital product (hereinafter called digital product DC) sent from information terminal 2 owned by a participant.

First, price determiner 112 obtains the quantity of sales and the resell order count of digital product DC from product DB 131. Then, price determiner 112 sets a price from the net quantity of sales of digital product DC based on the quantity of sales and the resell order count, and each net quantity of sales of referrers in referrers list RRL (step S101). In this step, price determiner 112 sets the price of the digital product by employing a pricing function that takes, as arguments, the net quantity of sales obtained by subtracting the resell order count from the latest quantity of sales prior to receiving the buy order, and each net quantity of sales of the referrers in referrers list RRL.

Next, reseller determiner 116 identifies the participant identification number of the participant who sells the digital product DC in resell order queue ST1 of digital product DC stored in product DB 131 (step S102). As resell order queue ST1 is a last-in-first-out stack accumulating participant identification numbers, when reseller determiner 116 obtains the participant identification number of the reseller from resell order queue ST1 of the digital product DC, the participant identification number last added to resell order queue ST1, that is, the participant identification number of the participant who resell ordered last is deleted from the queue. In this way, resell order queue ST1 is updated (step S103). If no participant has resell-ordered and the resell order count is zero, resell order queue ST1 is empty, having no participant identification number of any reseller. Then, reseller determiner 116 deletes no resell-order from the list.

Next, based on accounts payable and accounts receivable, transaction manager 115 generates, for each participant involved, an issued account payable, an issued account receivable, a received account payable, and a received account receivable, and stores these records into accounts payable and accounts receivable DB 136 (step S104). Transaction manager 115 periodically checks consistency in issued accounts payable list LS11, issued accounts receivable list LS12, received accounts payable list LS13, and received accounts receivable list LS14 for each participant, and generates balance data by calculating a difference between the sum of the prices over all issued accounts payable in issued accounts payable list LS11 and the sum of the prices over the issued accounts receivable in issued accounts receivable list LS12.

Then, transaction manager 115 updates product owners list LS2 by adding the participant identification number of the buyer who has just bought the digital product to product owners list LS2 stored in product DB 131 (step S105).

Meanwhile, a participant is allowed to buy an identical product for multiple times. In other words, for example, buying L identical digital products is equivalent to buying it L times. In the present commerce system, the price is determined according to the net quantity of sales. Thus, it is impossible to buy L identical digital products at an identical price. Assuming that the digital product is bought L times while no other transactions of the digital product take place, the price at the last L-th buy is higher than the price at the initial first buy because the net quantity of sales increases by (L−1). The same applies to resell orders. A participant who bought an identical digital product L times is allowed to resell-order up to L times. However the price fixed when the resell transaction is contracted differs among the resell transactions. As described above, although an identical product can be bought for multiple times, the price of that product differs from one transaction to another, which mechanism makes it difficult to profit an enormous amount by buying a certain digital product in a large quantity at a low price and reselling the digital product in a large quantity at much higher price. During the series of buys in large quantities starting from a low price, the price rises every time a buy order is contracted. During a series of resell orders, the price falls. Even if a participant resell-order a product aiming at reselling in a large quantity, it is unlikely to have those resells contracted before the price starts falling. In this case, the buyer is added L times into product owners list LS2 for that particular product. In the case of the series of L buys, the above-described steps from S101 to S105 are repeated L times. Thus, assuming that the participant thereafter resells the digital product (L−1) times, the participant is removed from product owners list LS2 (L−1) times. As a result, the participant remains as an owner in product owners list LS2. A contracted transaction is irrelevant to whether the digital product is actually downloaded by the participant who bought the digital product. Therefore, participants are allowed to buy a digital product without actually downloading the digital product. This might create a situation in which the commerce market managed by commerce management device 1 is used merely as remittance means. Since whatever digital products to transact in the commerce market are all available for all participants to buy, such digital products that are the so-called meaningless dummy used merely for a remittance purpose are detected, and the participants have an opportunity to bring an accusation of such digital product as an abuse of the market.

In the event that multiple participants simultaneously attempt to buy a single digital product, a transaction conflict might occur. To avoid this, as soon as the procedure for buying a certain digital product by one participant starts, commerce management device 1 according to the present embodiment keeps waiting the other participants' procedures of buying that digital product. In the event that multiple participants simultaneously attempt to resell order a single digital product, a transaction conflict might occur. To avoid this, as soon as the process for resell-ordering by one participant starts, commerce management device 1 according to the present embodiment keeps waiting the other participants' procedures of resell-ordering the product. On the other hand, commerce management device 1 handles in parallel multiple transactions that are independent of one another and that would cause no conflict.

As described above, in commerce management device 1 according to the present embodiment, price determiner 112 sets the price of digital product by employing a pricing function that returns a price of digital product taking, as arguments, the net quantity of sales obtained by subtracting the resell order count from the quantity of sales and each net quantity of sales of the referrers in referrers list RRL. In other words, the price of digital product is solely dependent on the net quantity of sales obtained by subtracting the resell order count from the quantity of sales and on each net quantity of sales of the referrers, without regard to the specific products, data size, or the producer of the digital product (needless to say, a digital product having excellent contents or produced by a famous producer may be in high demand, and thus the quantity of sales is very likely to increase to boost price). Hence, the transaction price (selling or reselling price) of digital product is automatically and dynamically set without the need for estimating the net quantity of sales of the digital product beforehand by the participant who sells the digital product, thereby facilitating the electronic commerce of digital products. Price determiner 112 prices the digital product by employing a pricing function that monotonically increases with the increase in the net quantity of sales, which reflects demand of the digital product from participants, and also monotonically increases with the increase in some referrers' net quantities of sale. Thus, if the digital product is in increasing demand or some of the referrers are in increasing demand, the buyer has a chance to resell the digital product at a price higher than the purchase price to make a resale profit. Hence, the buyer has a chance to gain speculative profit in a fair manner without fraudulent activities such as unauthorized reproduction and redistribution of paid digital product that the buyer bought, whereby expected is the effect of repressing unauthorized reproduction and redistribution of digital product. In addition, the foregoing pricing method allows the buyer of a digital product to assess the digital product and decide which strategy to take, such as, keeping it until the price rises if the digital product is evaluated to be of high value, and quickly reselling before the price starts falling if the digital product is evaluated to be of low value. Consequently, the price fluctuates according to collective opinions of evaluations made by multiple individual buyers. In other words, the price represents the value itself of a digital product as determined by collective opinions of buyers, where the value is more reliable than evaluations based on, for example, the number of “I like it” as often seen in the Internet services (in the case of “like” or similar options, voters do not buy the right to vote for “like” but may vote irresponsibly or may even be bribed into voting so that the number of “likes” falsely increases). Therefore, the price of digital products fairly reflects demand of participants for those digital products, thereby enhancing distribution of digital products in the digital product electronic commerce market managed by commerce management device 1, and consequently enhancing digital product development.

The pricing function, which is used by price determiner 112 according to the present embodiment and which takes, as arguments, the net quantity of sales and each net quantity of sales of the referrers, monotonically increases with the increase in the total net quantity of sales. This assures that the transaction price rises with the increase in the net quantity of sales, which grows with increasing demand for the digital product. On the other hand, the pricing function monotonically decreases with the increase in the resell order count. The increase in the resell order count represents decreasing demand for the digital product, which results in a decrease in the net quantity of sales. In this case, it is assured that the price as determined by the pricing function will fall. However, despite any price fall, the producer of a digital product does not suffer from fall in sales of the digital product that has already been sold (unless the producer buys the digital product produced by itself).

The pricing function, which is employed by price determiner 112 according to the present embodiment and which takes, as arguments, the net quantity of sales and each referrer's net quantity of sales, monotonically increases with the increase in each referrer's' net quantity of sales. Thus, when certain digital product gives a rise to a larger number of derivative digital products (secondary digital product), the price is more likely to rise. In other words, digital product with higher applicability, adaptivity, and evolvability is of higher value. Hence, when a certain digital product is referred to by a larger number of other digital products, the digital product has higher speculative value and is in higher demand. As a result, a considerable amount of sales is brought to the producers of such digital products referred to by a large number of other digital products. Therefore, a producer of a primary digital product can receive a fair amount of money without receiving license fees such as copyright fees or patent royalties from producers of derivative secondary digital products that refer to the primary digital product. Thus, participants are encouraged to refer to primary digital products, resulting in repressed fraudulent secondary products that do not refer to primary digital products.

In commerce management device 1 according to the present embodiment, the sales price of each digital product fluctuates with its net quantity of sales. Accordingly, any participant can earn the resale profit by reselling digital products at a price higher than the purchase price. This is an incentive for a participant to transact with other participants in the digital product electronic commerce market managed by commerce management device 1, thereby repressing unauthorized distribution of digital product to non-participants. Furthermore, each participant is expected to frequently invite non-participants to participate in the electronic commerce market managed by commerce management device 1 so as to guarantee resale profits for the participant. This brings the advantage of expanding the digital product electronic commerce market managed by commerce management device 1.

In addition, in the digital product commerce system according to the present embodiment, transactions are conducted by exchanging accounts receivable and accounts payable. This gives the advantages of preventing currency shortages that could be caused by much more frequent transactions, and of preventing a phenomenon like inflation that could be caused by excessive issuance of currency to compensate for such currency shortages. Since an absolute value of each exchanged digital product is set based on its net quantity of sales, the exchange rate between the value and the currency for settlement is stabilized. Improving the security of transactions in the digital product electronic commerce market in this way results in expansion of participants of the electronic commerce market. Consequently, the electronic commerce market has a greater transaction volume, which can furthermore bring the advantage of raising average sales prices in commercial transactions. Such advantage represents a market expansion leading to economic growth itself and thus contributes to the growth in GDP. In particular, digital products have conventionally had a tendency to be distributed free of charge or sold at a very low price that is virtually zero because their marginal cost is almost zero. However, introducing the mechanism of the foregoing digital product commerce will turn the distribution of digital product into economic activities, which are expected to enhance economic development.

Textboard provider 117 according to the present embodiment provides a textboard to the participant who produced a certain digital product and to the participants who have bought the digital product. Thus, the participant who produced the digital product and the participants who bought the digital product can communicate with each other in the textboard. As a result, the participant who produced the digital product is allowed to, for example, improve the digital product by accepting opinions, as useful referents, from the participants who bought the product. Suppose here that the producer of a certain digital product has developed a new digital product based on the digital product that is already on the market. Then, the participant who has produced that new digital product can make a sales announcement of the new digital product in the textboard to the participants who bought the primary digital product. If the digital product is a piece of software, the textboard facilitates support for using the software and interconnection among users to improve the environment for using the software. Furthermore, the digital product may be something like a proposal for a research and development project, in which case the textboard facilitates collaborative developments by a large number of participants. Such projects will fork new projects with ease, and these new projects may become widespread in the form of new digital products, and consequently innovation will be enhanced.

In commerce management device 1 according to the present embodiment, when the balance data stored in accounts payable and accounts receivable DB 136 indicates a negative balance, the balance can be reset to zero by cash payment. When the balance data indicates a positive balance, the balance can be reset to zero by receiving a cash payment. However, the balance cannot be changed to positive by making a payment when the balance is negative. Also the balance cannot be changed to negative by receiving a cash payment when the balance is positive. Accordingly, commerce management device 1 is out of scope of application of laws relating to prepaid settlement (issuance of so-called prepaid cards and gift certificates) or relating to financial transactions. In other words, commerce management device 1 has an advantage of the ability to run a business according to the present disclosure without assistance from financial institutes.

In commerce management device 1, the transaction price for selling or reselling digital product DC is automatically set based on the quantity of sales and of the resell order count. This does not lead to price control in fair trade. The reasons are as follows. Regarding the sales price, the manager of commerce management device 1 is entrusted by contract to sell digital product DC using commerce management device 1 by the producer of digital product DC. The manager of commerce management device 1 can thus set a transaction price at the manager's discretion. Therefore, the pricing by the manager adopting a price determined by commerce management device 1 for exchanging digital product DC does not lead to price control. Regarding the resale price of digital product DC, a participant who desires to resell digital product DC can freely set a resale price within a certain range by selecting the timing when to resell digital product DC. Therefore, adopting a resale price determined by commerce management device 1 does not lead to price control.

Commerce management device 1 according to the present embodiment makes it possible to record a charge imposed on every transaction of digital product or a participantship charge for participating in the digital product commerce market managed by commerce management device 1 as operating revenue. It is also possible to supply a daemon program for implementing commerce management device 1 or a client program running on information terminal 2 to the commerce market. Commerce management device 1 enables the manager of the digital product market to collect a charge imposed on every transaction of digital product, a participantship fee from a participant, and other charges by issuing accounts receivable.

### Variations

Embodiments of the present disclosure have been described above, but the present disclosure is not limited to the configurations of the foregoing embodiments. For example, the commerce management device may manage a market of those ordinary commercial products which are not regarded as having a zero marginal cost, which are difficult to reproduce, and which suffer from deterioration when in use, unlike digital product described above. In this case, the price determiner may set a price of the product by adding an amount equivalent to the marginal cost of the product to the above-described sales price, and may set a resale price of the product by further subtracting an amount equivalent to deterioration of the product. Alternatively, a plan or specifications of a new commercial product may be sold as a digital product in the present commerce market, and the sales amount may be invested in manufacturing the product. The demand for a physical commercial product can be grasped from the quantity of sales of such plans or specifications, and accordingly, the product can be delivered to the participant who bought the plan or specifications at a marginal cost. This leads to forming a futures market for the new commercial product, resulting in enhancing innovations.

Secondary products derived from a digital product distributed in the market managed by commerce management device 1 may be physical products instead of digital. In this case, when the physical products equivalent to the secondary products are sold outside the market managed by commerce management device 1, the quantity of sales of such products may be periodically reported to commerce management device 1. In this way, the quantities of sales of the physical products equivalent to secondary products can contribute to the rise in the price of the primary digital product in the market managed by commerce management device 1.

Then, the manufacturer and seller of the physical products equivalent to secondary products are only requested to report the quantity of sales of the physical products equivalent to secondary products periodically to commerce management device 1, without the need for paying license fees or the likes to the producer of the primary digital product. Hence, the producer of the primary digital product can receive a fair amount of money due to the increase in demand arising from a higher speculative value of the primary digital product, where the speculative value depends on the quantity of sales of those physical products equivalent to secondary products. In this way, the quantity of sales of those physical products equivalent to secondary products sold outside the market managed by commerce management device 1 can be reflected in the market managed by commerce management device 1, whereby innovation of digital products can be enhanced.

Commerce management device 1 according to the present embodiment may also be used for crowdfunding, which has recently been drawing attention. Specifically, when a written plan such as a business plan, a business model proposal, or a product plan is listed as a digital product on the commerce market according to the present embodiment, participants who support the plan buy the digital product, namely the written plan, whereby an investment is made. Then, investors and speculators other than these supporters may be induced to buy the digital product merely for speculative purposes in the hope of making profit, and thus a fund may be raised by a larger number of stakeholders than in ordinary crowdfunding. In this case, textboard provider 117 according to the present embodiment can provide a place of discussions to stakeholders and the business operator, that is, a mechanism of electronically holding a meeting equivalent to a general shareholders' meeting. Therefore, commerce management device 1 according to the present embodiment can be used as a management device for a market in which business plans and others are exchanged as investment securities (stocks) and as a management device for a place of discussions among stakeholders and the business operator.

In the textboard provided by commerce management device 1 according to the present embodiment, general problems like vandalism or inundated messages are suppressed. This is because the participants eligible to write messages are limited to those who bought the digital product, and careless comments may reduce the speculative value of the digital product. Hence, there is created an implicit demand that constructive statements should be made on the textboard.

Commerce management device 1 according to the embodiment may further provide a commission charge manager that issues an account receivable equivalent to a commission charge to at least one of two participants who are exchanging digital products. This configuration makes it easy to collect commission charges from participants who are conducting transactions in the digital product electronic commerce market.

In the present embodiment, an alarm may be issued to a relevant participant when the difference between the sum of prices over issued accounts payable and the sum of prices over issued accounts receivable, as stored in accounts payable and accounts receivable DB 136, exceeds a difference threshold. This prevents a participant from issuing excessive accounts payable beyond the participant's solvency.

In an embodiment, instead of information terminal 2, devices like a stationary monitoring camera or experiment device, or a robot program collecting big data over the Internet may send product data to commerce management device 1.

Commerce management device 1 and information terminal 2 may together be implemented on a single server (software).

In an embodiment, the foregoing advertisement information may include a list of buyers who have bought at least a certain base quantity of digital product DC. In this case, digital product DC can be used as an advertising medium showing sponsors in the advertisement information containing a list of names of people or organizations (such as companies) that are volume buyers of digital product DC. In addition to personal names or organization names, URLs may be listed so as to guide to the advertising product that can be viewed free of charge.

In the example described in the embodiment, the pricing function employed by price determiner 112 takes, as arguments, the net quantity of sales and each referrer's net quantity of sales, but the function is not limited to this pricing function. For example, the pricing function may take, as an argument, the number obtained by adding 2 to the net quantity of sales as in the aforementioned equation (1).

Various functions of the commerce management device according to the present disclosure can be implemented by using not only a special-purpose system but also a general computer system. For example, the commerce management device executing the above-described process may be configured by storing a program for executing the above-described operations into a non-transitory computer-system-readable recording medium (CD-ROM, for example), distributing the medium to a computer connected to a network, and installing the program on a computer system.

Any method may be used to provide the program to a computer. For example, the program may be uploaded to a textboard on a communication line and delivered to a computer through the communication line. Then, the computer starts and executes the program under control of an OS as with other applications. In this way, the computer functions as the commerce management device executing the above-described process.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, with the full range of equivalents to which such claims are entitled.

This application claims the benefit of Japanese Patent Application No. 2016-224123, filed on Nov. 17, 2016, and Japanese Patent Application No. 2017-075547, filed on Apr. 5, 2017, of which the entirety of the disclosures is incorporated by reference herein.

### REFERENCE SIGNS LIST

1 Commerce management device
2 Information terminal
101 CPU
102 Main memory
103 Auxiliary memory
104 Communicator
105 Bus
111 Product manager
112 Price determiner
113 Sales quantity calculator
114 Resell order count calculator
115 Transaction manager
116 Reseller determiner
117 Textboard provider
118 Referrer sales quantity and resell order count calculator
131 Product DB
136 Accounts payable and accounts receivable DB
137 Textboard DB
DC Digital product
LS1 Transaction log
LS2 Product owners list
LS11 Issued accounts payable list
LS12 Issued accounts receivable list
LS13 Received accounts payable list
LS14 Received accounts receivable list
REL Referents list
RRL Referrers list
ST1 Resell order queue

1: A digital product commerce management device that manages electronic commerce of digital products, the digital product commerce management device comprising:
a transaction log storage in which a transaction log regarding each digital product produced by a participant participating in the electronic commerce is recorded;
a sales quantity calculator that calculates, based on the transaction log, a quantity of sales of the digital product;
a resell order queue in which a resell order form issued by the participant regarding the digital product is enqueued;
a resell order count calculator that calculates, based on the resell orders recorded in the resell order queue, a resell order count; and
a price determiner that determines a price at the next transaction by employing a monotonically increasing function that calculates a price by taking, as an argument, a net quantity of sales obtained by subtracting the resell order count from the quantity of sales, an identical monotonically increasing function being applied to all digital products.

2: The digital product commerce management device according to claim 1, further comprising:
a referrers list in which digital products referring to that digital product are registered; and
a referrer sales quantity and resell order count calculator that calculates each net quantity of sales of referrers in the referrers list,
wherein the price determiner determines the price in the next transaction by employing a monotonically increasing function that calculates the price in the next transaction contracted by taking, as an argument, in addition to the net quantity of sales, each net quantity of sales of its referrers, where an identical monotonically increasing function is applied to all digital products.

3: The digital product commerce management device according to claim 1, further comprising:
a reseller determiner that identifies a resell order form issuer who resells the digital product to a participant having an intention of buying the digital product,
wherein, when no resell order exists, the reseller determiner identifies, upon obtaining a buy order of the digital product by the participant, a participant who produced the digital product.

4: The digital product commerce management device according to claim 3, further comprising:
a resell order queue manager that manages each resell order by each participant,
wherein, when the multiple resell orders are present, the reseller determiner identifies, upon receiving the buy order by a participant, who resell-ordered last among the multiple resell orders.

5: The digital product commerce management device according to claim 1, further comprising:
a textboard provider that provides a textboard to a participant whose participant identification number is registered in a product owners list that is a list of participant identification numbers of the participants who bought the digital product, and to a participant who produced the digital product.

6: The digital product commerce management device according to claim 1,
wherein the monotonically increasing function is a logarithmic function to base 2, multiplied by an exchange rate, the logarithmic function taking, as an argument, an integer obtained by adding 2 to the net quantity of sales.

7: A digital product commerce management method for managing electronic commerce of digital products, the method comprising steps of:
calculating, based on the transaction log of a digital product produced by a participant in the electronic commerce of the digital products, a quantity of sales of the digital product;
calculating, based on a resell order forms issued by the participant regarding the digital product, a resell order count; and
determining a price at the next transaction by employing a monotonically increasing function that calculates the price by taking, as an argument, a net quantity of sales obtained by subtracting the resell order count from the quantity of sales, an identical monotonically increasing function being applied to all digital products.

8: A non-transitory recording medium storing a program causing a computer to function as:
a sales quantity calculator that calculates, based on a transaction log of a digital product produced by a participant in electronic commerce, a quantity of sales of the digital product;
a resell order count calculator that calculates, based on a resell order forms issued by the participant regarding the digital product, a resell order count; and
a price determiner that determines a price in the next transaction by employing a monotonically increasing function that calculates the price by taking, as an argument, a net quantity of sales obtained by subtracting the resell order count from the quantity of sales, an identical monotonically increasing function being applied to all digital products.

9: The digital product commerce management device according to claim 2, further comprising:
a reseller determiner that identifies a resell order form issuer who resells the digital product to a participant having an intention of buying the digital product,
wherein, when no resell order exists, the reseller determiner identifies, upon obtaining a buy order of the digital product by the participant, a participant who produced the digital product.

10: The digital product commerce management device according to claim 9, further comprising:
a resell order queue manager that manages each resell order by each participant,
wherein, when the multiple resell orders are present, the reseller determiner identifies, upon receiving the buy order by a participant, who resell-ordered last among the multiple resell orders.

11: The digital product commerce management device according to claim 2, further comprising:
a textboard provider that provides a textboard to a participant whose participant identification number is registered in a product owners list that is a list of participant identification numbers of the participants who bought the digital product, and to a participant who produced the digital product.

12: The digital product commerce management device according to claim 3, further comprising:
a textboard provider that provides a textboard to a participant whose participant identification number is registered in a product owners list that is a list of participant identification numbers of the participants who bought the digital product, and to a participant who produced the digital product.

13: The digital product commerce management device according to claim 4, further comprising:
a textboard provider that provides a textboard to a participant whose participant identification number is registered in a product owners list that is a list of participant identification numbers of the participants who bought the digital product, and to a participant who produced the digital product.

14: The digital product commerce management device according to claim 9, further comprising:
a textboard provider that provides a textboard to a participant whose participant identification number is registered in a product owners list that is a list of participant identification numbers of the participants who bought the digital product, and to a participant who produced the digital product.

15: The digital product commerce management device according to claim 10, further comprising:
a textboard provider that provides a textboard to a participant whose participant identification number is registered in a product owners list that is a list of participant identification numbers of the participants who bought the digital product, and to a participant who produced the digital product.

16: The digital product commerce management device according to claim 2,
wherein the monotonically increasing function is a logarithmic function to base 2, multiplied by an exchange rate, the logarithmic function taking, as an argument, an integer obtained by adding 2 to the net quantity of sales.

17: The digital product commerce management device according to claim 3,
wherein the monotonically increasing function is a logarithmic function to base 2, multiplied by an exchange rate, the logarithmic function taking, as an argument, an integer obtained by adding 2 to the net quantity of sales.

18: The digital product commerce management device according to claim 4,
wherein the monotonically increasing function is a logarithmic function to base 2, multiplied by an exchange rate, the logarithmic function taking, as an argument, an integer obtained by adding 2 to the net quantity of sales.

19: The digital product commerce management device according to claim 5,
wherein the monotonically increasing function is a logarithmic function to base 2, multiplied by an exchange rate, the logarithmic function taking, as an argument, an integer obtained by adding 2 to the net quantity of sales.
